(19) United States
(12) Patent Application Publication
(10) Pub. No.: US 2019/0248184 A1
(43) Pub. Date: Aug. 15, 2019

(54) REINFORCING ELEMENT, ELASTOMER COMPOSITE AND TIRE COMPRISING SAID REINFORCING ELEMENT

(71) Applicant: COMPAGNIE GENERALE DES ETABLISSEMENTS MICHELIN, CLERMONT-FERRAND (FR)

(72) Inventors: JÉRÉMY GUILLAUMAIN, CLERMONT-FERRAND (FR); GUILLAUME ANDRE, CLERMONT-FERRAND (FR); SOLENNE VALLET, LYON (FR); JULIEN VENUAT, CLERMONT-FERRAND (FR)

(73) Assignee: COMPAGNIE GENERALE DES ETABLISSEMENTS MICHELIN, CLERMONT-FERRAND (FR)

(21) Appl. No.: 16/333,332

(22) PCT Filed: Sep. 15, 2017
(86) PCT No.: PCT/FR2017/052467

§ 371 Date: Mar. 14, 2019

(30) Foreign Application Priority Data
Sep. 19, 2016 (FR) 1658764

(51) Int. Cl. B60C 9/00; B60C 17/00; D02G 3/48; D02G 3/26; D02G 3/02

(52) U.S. Cl. CPC B60C 9/005; B60C 17/0009; B60C 9/0042; D02G 3/48; B60C 2009/0433; D02G 3/02; B60C 2017/0072; B60C 2009/0092; B60C 2009/0078; D02G 3/26

(57) ABSTRACT

The reinforcing element (45) comprises an assembly (49) made up: of a multifilament strand made of aromatic polyamide or aromatic copolyamide (46) and of a multifilament strand made of polyester (48). The two strands (46, 48) are wound in a helix around one another, and the reinforcing element (45) is twist-balanced. The twist factor K of the reinforcing element (45) ranges from 5.5 to 6.5 where K is defined by the formula: K=(R×Ti^{1/2})/957 in which R is the twist of the reinforcing element (45) expressed in twists per metre and Ti is the sum of the counts of the multifilament strands of the reinforcing element (45) in tex.

The invention relates to a reinforcing element comprising a multifilament strand made of aromatic polyamide or aromatic copolyamide and a multifilament strand made of polyester, which strands are assembled with one another. The invention also relates to an elastomer composite comprising this reinforcing element and to a tyre comprising a carcass ply obtained from this composite.

For many years, tyre manufacturers have been seeking to improve tyre carcass reinforcements in order to increase their force at break notably in an attempt to combat what are referred to as “road hazards” of the kerbing, potholes, etc. type, while at the same time maintaining good durability. Carcass reinforcement durability is essential for ensuring long tyre life.

A tyre comprising a carcass reinforcement comprising a single carcass ply comprising several reinforcing elements is known from the prior art. Each reinforcing element comprises two multifilament strands made of polyester which are assembled with one another and wound in a helix around one another at a twist of 270 twists per metre. Each multifilament carcass strand has a relatively high count equal to 334 tex. This reinforcing element has a twist factor equal to 7.3 and a diameter equal to 0.96 mm.

This carcass ply is obtained from a composite comprising an elastomer composition in which the reinforcing elements are embedded. During the manufacture of this composite, for example by skimming, the reinforcing elements move along, and two strips made of the elastomer composition, referred to as elastomer skims, are brought in, one on each side of the reinforcing elements, so that the reinforcing elements are sandwiched between the two elastomer skims. These two elastomer skims are relatively thick so that a sufficient quantity of the elastomer composition fills the space between two adjacent reinforcing elements in order to ensure correct formation of bridges of the elastomer composition as required for the cohesion between the reinforcing elements achieved via the elastomer composition.

The composite thus obtained has a relatively high thickness of 1.47 mm, with a density of 80 reinforcing elements per decimetre of composite.

The composite and the carcass ply obtained from this composite are therefore relatively heavy because of the relatively high diameter of the reinforcing elements and because of the thickness of the two elastomer skims needed for the correct skimming of these reinforcing elements.

Those skilled in the art are therefore seeking to reduce the mass of tyres, particularly by reducing the thickness of the carcass ply.

There are two solutions habitually implemented. The first is to reduce the density of reinforcing elements. The second is to increase the force at break of each reinforcing element.

By reducing the density of reinforcing elements in the carcass ply, for example to 60 reinforcing elements per decimetre, the carcass ply is lightened in weight, but this leads to a reduction in the force at break of this ply. This reduction in the force at break of the carcass ply leads to a drop in tyre performance with regard to road hazards, and this is obviously not desirable.

By increasing the force at break of each reinforcing element, notably by reducing the twist, for example to 230 twists per metre, the durability will be significantly reduced, and this is something that is detrimental to tyre life.

These two solutions are therefore incompatible with the performance desired of the carcass ply, particularly the second solution which involves reducing the twist, thereby lessening the durability, a performance aspect which is essential to the carcass ply.

Other solutions have been developed, notably in document EP2233318. Nevertheless, these solutions are industrially complex and ill-suited, in terms of cost and/or of performance, to the vast majority of tyre uses, which uses predominantly correspond to uses in non-sports vehicles.

It is an object of the invention to find a reinforcing element that makes it possible to manufacture an elastomer composite that makes it possible to obtain a carcass ply that is relatively lightweight and capable of being used in numerous types of tyre corresponding to highly varied uses, for example to uses ranging from those corresponding to urban vehicles to those corresponding to sports vehicles. Another object of the invention is to find a reinforcing element that makes it possible to manufacture an elastomer composite that makes it possible to obtain a carcass ply that has a satisfactory force at break able to combat road hazards, and has count and twist characteristics that allow the tyre designer to adapt the other tyre performance aspects, for example the durability, to suit the use for which the tyre is intended.

To this end, one subject of the invention is a reinforcing element comprising an assembly made up:
of a multifilament strand made of aromatic polyamide or aromatic copolyamide, and
of a multifilament strand made of polyester,
   the two strands being wound in a helix around one another and the reinforcing element being twist-balanced, the twist factor K of the reinforcing element ranging from 5.5 to 6.5 with K being defined by the formula K=(R×Ti^{1/2})/957
   in which R is the twist of the reinforcing element expressed in twists per metre and Ti is the sum of the counts of the multifilament strands of the reinforcing element in tex.

Regarding the filament made of aromatic polyamide or aromatic copolyamide, it will be recalled that, as is well known, this is a filament of linear macromolecules formed of aromatic groups held together by amide bonds of which at least 85% are directly connected to two aromatic cores, and more particularly of fibres made of poly(p-phenylene terephthalamide) (or PPTA), which have been being manufactured for a long time from optically anisotropic spinning compositions. Among aromatic polyamides or aromatic copolyamides, mention may be made of polyaryl amides (or PAA, notably known by the Solvay company trade name Ixef), poly(metaxylylene adipamide), polyphthalamides (or PPA, notably known by the Solvay company trade name Amodel), amorphous semiaromatic polyamides (or PA 6-3T, notably known by the Evonik company trade name Trogamid), meta-aramids (or poly(metaphenylene, isophthalamide or PA MPD-I notably known by the Du Pont de Nemours company trade name Nomex) or para-aramids (or poly(paraphenylene terephthalamide or PA PPD-T notably known by the Du Pont de Nemours company trade name Kevlar or the Teijin company trade name Twaron).

Regarding the polyester filament, it will be recalled that this is a filament of linear macromolecules formed of groups held together by ester bonds. Polyesters are produced by polycondensation by esterification between a carboxylic diacid, or one of the derivatives thereof, and a diol. For example, polyethylene terephthalate can be manufactured by the polycondensation of terephthalic acid and ethylene glycol. Examples of known polyesters include polyethylene terephthalate (PET), polyethylene naphthalate (PEN), polybutylene terephthalate (PBT), polybutylene naphthalate (PBN), polypropylene terephthalate (PPT) or polypropylene naphthalate (PPN).

What is meant by twist-balanced is that the two multifilament strands are wound with substantially the same twist and that the twist of the monofilaments of each multifilament strand, namely the twist of the monofilaments of the multifilament strand made of aromatic polyamide or copolyamide and the twist of the monofilaments of the strand made of polyester, is substantially zero. Specifically, the method of manufacturing these reinforcing elements, which is well known in the prior art, involves a first step during which each spun yarn of monofilaments (more properly referred to as a “yarn”) is first of all twisted individually on itself (with an initial twist R1′ and R2′ with R1′=R2′) in a given direction D′=D1′=D2′ (respectively in the S or Z direction, according to recognized terminology denoting the orientation of the turns according to the transverse bar of an S or of a Z) to form a strand or overtwist (more properly referred to as a “strand”) in which the monofilaments find themselves deformed into a helix around the axis of the strand. Then, during a second step, the two strands are then twisted together with a final twist R3 such that R3=R1′=R2′ in a direction D3 that is the opposite to the direction D′=D1′=D2′ (respectively Z or S direction) to obtain the reinforcing element (more properly referred to as a “cord”). This reinforcing element is then said to be twist-balanced because the monofilaments of the two strands, in the final reinforcing element, have the same residual twist because R1′=R2′. This residual twist is zero or near-zero because R3=R1′=R2′ and the direction D′=D1′=D2′ is the opposite of the direction D3. What is meant by a near-zero residual twist is that the residual twist is strictly below 2.5% of the twist R3.

What is meant by an “assembly made up of” is that the assembly comprises no multifilament strand other than the two multifilament strands made of aromatic polyamide or aromatic copolyamide and made of polyester.

Within the selected twist factor interval, for a given count, the tyre reinforcing element has a force at break that is relatively constant, thereby allowing the tyre designer to adapt other characteristics of the reinforcing element, notably the twist, to suit the use or uses for which the tyre is intended. Furthermore, within the selected twist factor interval, the reinforcing element has a durability compatible with most present-day tyre uses.

The composite comprising the reinforcing element according to the invention offers the advantage of allowing the tyre designer to use a single carcass ply in the tyre while at the same time maintaining, on the one hand, a force at break that is high enough to combat road hazards and, on the other hand, durability compatible with most present-day tyre uses.

For a given count, the higher the twist, the greater the industrial risk of experiencing a high level of spread on the force at break of the reinforcing elements. Thus, by comparison with reinforcing elements which, for a given count, have a high twist factor, which means to say one strictly higher than 6.5, the selected twist factor interval makes it possible to choose reinforcing elements that have a lower twist and are therefore liable to lead to less spread on the force at break of the reinforcing element.

The multifilament strand made of aromatic polyamide or of aromatic copolyamide and the multifilament strand made of polyester are assembled with one another and wound into a helix one around the other.

The twist factor, hereinafter designated by the letter K (also known as the twist multiplier), is defined by the formula:

K=(R×Ti^{1/2})/957

in which R is the twist of the reinforcing element expressed in twists per metre (twist R3 described hereinabove) and Ti is the sum of the counts of the multifilament strands of the reinforcing element in tex.

The twist R of the reinforcing element can be measured using any method known to those skilled in the art, for example in accordance with standards ASTM D1423 or ASTM D 885/D 885MA, January 2010 (paragraph 30), for example using a torsiometer.

The count (or linear density) of each strand is determined in accordance with standard ASTM D1423. The count is given in tex (weight, in grams, of 1000 m of product—remembering that: 0.111 tex is equal to 1 denier).

In one advantageous embodiment, the reinforcing element also comprises a layer of an adhesive composition coating the assembly made up of the two strands. Such an adhesive composition is, for example, of the RFL (Resorcinol-Formaldehyde-Latex) type.

Advantageously, the twist factor K of the reinforcing element ranges from 5.5 to 6.5, the value 5.5 being excluded, that is to say it belongs to the interval ]5.5; 6.5] (which means to say excluding the value 5.5). The twist factor K of the reinforcing element preferably ranges from 5.6 to 6.1 and more preferably still from 5.9 to 6.1. Thus, for a given count, the risk of spread on the force at break of the reinforcing element is reduced still further.

Advantageously, the twist of the reinforcing element ranges advantageously from 275 to 365 twists per metre, preferably from 275 to 350 twists per metre, and more preferably still from 300 to 330 twists per metre. For a given count, within this twist interval, the reinforcing element has sufficient durability to be used in a tyre suited to most present-day uses and a relatively low risk of spread on its force at break.

Advantageously, the count of the multifilament strand made of aromatic polyamide or aromatic copolyamide ranges from 140 to 210 tex, preferably from 150 to 190 tex, and more preferably from 160 to 180 tex. Within the twist-factor interval according to the invention, by using counts lower than the intervals described hereinabove, the reinforcing element would exhibit a relatively high twist, and this would lead to a risk of spread on the force at break. Conversely, within the twist-factor interval according to the invention, by using counts higher than the intervals described hereinabove, the reinforcing element would exhibit a relatively low twist, and this would lead to a risk of reduced durability. Thus, the count intervals for the multifilament strand made of aromatic polyamide or aromatic copolyamide which are described hereinabove make it possible preferably to obtain a good compromise between force at break and durability.

Advantageously, the count of the multifilament strand made of polyester ranges from 100 to 210 tex, preferably from 120 to 190 tex, more preferably from 130 to 180 tex, more preferably still from 160 to 180 tex. In a similar way to the count of the multifilament strand made of aromatic polyamide or aromatic copolyamide, in the count intervals for the multifilament strand made of polyester which are described hereinabove, the reinforcing element preferably exhibits a good compromise between force at break and durability.

Advantageously, the initial tensile modulus of the reinforcing element ranges from 5.0 to 10.5 cN/tex. The initial modulus is related to certain performance aspects of the reinforcing element with respect to small deformations, notably the stiffness of the tyre. The tyre designer will thus be able to choose the initial modulus so as to adapt the reinforcing element, and therefore the tyre, to suit the use for which the tyre is intended.

For preference, the initial tensile modulus of the reinforcing element ranges from 5.7 to 8.5 cN/tex, more preferably from 6.2 to 7.8 cN/tex, more preferably still from 6.8 to 7.5 cN/tex. In effect, during the method for manufacturing a tyre according to the prior art, the carcass ply is wrapped and its two ends are superposed one on the other over a length of the order of one centimetre. In this superposition zone, the carcass ply has a double thickness and therefore a reinforcing-element density K that is twice as high as in the adjacent zones in which the carcass ply has a single thickness and therefore a reinforcing-element density K/2. This difference in the reinforcing-element densities between the superposition zone and the adjacent zones leads to a difference in stress loading between the reinforcing elements of each of these zones and therefore to a relatively significant difference in elongation between the reinforcing elements in each of these zones, leading to an unattractive deformation of the sidewall of the tyre.

Within these preferred initial-modulus intervals, with the initial modulus advantageously being relatively high, the difference in stress loading between the reinforcing elements of each of the zones leads to a relatively small difference in elongation and therefore makes it possible to reduce the unattractive problems of tyre sidewall deformation.

Advantageously, the final tensile modulus of the reinforcing element ranges from 14.0 to 21.5 cN/tex. The final modulus is related to certain performance aspects of the reinforcing element with respect to large deformations, notably the strength of the reinforcing element when the reinforcing element is exposed to a road hazard. The tyre designer will be able to choose the final modulus so as to make the reinforcing element as resistant as possible to most road hazards without thereby penalizing other performance aspects.

For preference, the final tensile modulus of the reinforcing element ranges from 15.0 to 19.0 cN/tex, more preferably from 15.8 to 18.5 cN/tex, more preferably still from 16.6 to 17.9 cN/tex.

The initial modulus is defined as being the gradient, at the origin, of the linear part of the force—elongation curve which occurs just after a standard tensile preload of 0.5 cN/tex. The final modulus is defined as being the gradient at the point corresponding to 80% of the force at break of the force—elongation curve. The force—elongation curve is obtained by measurement in the known way, using an “INSTRON” tensile test machine fitted with “4D” clamps. The samples tested are subjected to a tensile stress over an initial length of 400 mm at a nominal speed of 200 mm/min, under a standard tensile preload of 0.5 cN/tex.

Advantageously, the ratio of the final modulus to the initial modulus ranges from 2.10 to 2.75, preferably from 2.15 to 2.45, more preferably from 2.20 to 2.40, more preferably still from 2.25 to 2.40.

Another subject of the invention is an elastomer composite comprising at least one reinforcing element as defined above embedded in an elastomer composition.

What is meant by an elastomer composition is a composition comprising an elastomer, preferably a diene elastomer, for example natural rubber, and a reinforcing filler, for example carbon black and/or silica, and a crosslinking system, for example a vulcanizing system, preferably containing sulfur.

Advantageously, the density of reinforcing elements in the composite ranges from 80 to 145 reinforcing elements per decimetre of composite, preferably from 90 to 130 reinforcing elements per decimetre of composite, more preferably from 100 to 125 reinforcing elements per decimetre of composite, more preferably still from 105 to 120 reinforcing elements per decimetre of composite. Within these reinforcing-element density intervals, the composite has a relatively high force at break and a relatively low cost allowing it to be used in tyres suited to most uses.

The density of reinforcing elements in the composite is the number of reinforcing elements included in one decimetre of composite in the direction perpendicular to the direction in which the reinforcing elements run parallel to one another.

Advantageously, the ratio of the diameter of the reinforcing element to the thickness of the composite is strictly less than 0.65, preferably less than or equal to 0.62. In this way, the thickness of the composite and thus the hysteresis of the tyres is decreased in order to reduce the energy consumption of the vehicles fitted with such tyres.

Advantageously, the diameter of the reinforcing element is less than or equal to 0.95 mm, preferably less than or equal to 0.80 mm, more preferably less than or equal to 0.70 mm. The reinforcing element according to the invention extends in an overall direction G and the diameter of this reinforcing element is the diameter inside which this reinforcing element can be inscribed in a plane of section perpendicular to the direction G.

Advantageously, the thickness of the composite is less than or equal to 1.45 mm, preferably less than or equal to 1.30 mm, more preferably less than or equal to 1.20 mm. The thickness of the composite is the shortest distance between the two external surfaces of the composite, namely the distance measured in a direction perpendicular to the two external surfaces of the composite.

Yet another subject of the invention is a tyre comprising a carcass reinforcement comprising at least one carcass ply obtained from an elastomer composite as defined hereinabove.

The tyres of the invention in particular may be intended for motor vehicles of the passenger vehicle, 4×4 and SUV (Sport Utility Vehicle) type, but also for two-wheel vehicles, such as motorcycles, or for industrial vehicles such as underground trains, buses, heavy road transport vehicles (lorries, tractors, trailers), off-road vehicles and agricultural or civil engineering machinery.

For preference, the tyres may be intended for motor vehicles of the passenger vehicle, 4×4 or SUV (Sport Utility Vehicle) type.

Advantageously, the carcass reinforcement comprises a single carcass ply. The combined use of aromatic polyamide or aromatic copolyamide with polyester makes it possible to obtain a carcass ply that exhibits mechanical strength properties, notably force at break and endurance properties, which are high enough that they allow the tyre designer to limit the number of carcass plies in the carcass reinforcement to just one (rather than several) carcass ply. Thus, by reducing the number of carcass plies, the cost, the mass and also the hysteresis, and therefore the rolling resistance, of the tyre are reduced. Furthermore, the presence of a single carcass ply makes it possible to obtain a tyre with a carcass reinforcement that is more flexible than a tyre with a carcass reinforcement that comprises several carcass plies. The vertical stiffness of the tyre is thus limited.

In one embodiment, the tyre comprises a crown extended radially on the inside by two sidewalls, each sidewall being extended radially on the inside by two beads each comprising at least one annular reinforcing structure, the carcass reinforcement is anchored in each of the beads by a turnup around the annular reinforcing structure.

For preference, the reinforcing elements of the carcass ply are arranged side-by-side and parallel to one another in a main direction substantially perpendicular to the overall direction in which the reinforcing elements of the carcass ply extend, the overall direction making an angle ranging from 80° to 90° with the circumferential direction of the tyre.

In another embodiment, the tyre comprises a crown reinforcement arranged radially on the outside of the carcass reinforcement, the crown reinforcement comprising a working reinforcement comprising at least one, and preferably two, working plies. Optionally, each working ply comprises several working reinforcing elements, preferably made of metal, arranged side-by-side and substantially parallel to one another. Such working reinforcing elements make an angle ranging from 10° to 45° with the circumferential direction of the tyre. Advantageously, the working reinforcing elements are crossed from one working ply to the other.

For preference, the crown reinforcement comprises a hoop reinforcement positioned radially on the outside of the working reinforcement. Advantageously, the hooping ply comprises hoop reinforcing elements, preferably made of textile, arranged side-by-side and substantially parallel to one another. Such hoop reinforcing elements form an angle of at most equal to 10°, preferably ranging from 5° to 10°, with the circumferential direction of the tyre.

In the present application the term “textile” in very general terms means any material made of a substance other than a metallic substance, whether it be natural or synthetic, which is capable of being transformed into a thread, fibre or film by any appropriate transformation process. Mention may be made, for example, without the examples below being limiting, of a polymer spinning process, such as, for example, melt spinning, solution spinning or gel spinning.

Although materials made of a non-polymeric substance (for example made of a mineral substance such as glass or made of a non-polymeric organic substance such as carbon) are included in the definition of the textile material, the invention is preferably carried out with materials made of a polymeric substance, of both thermoplastic and non-thermoplastic type.

By way of examples of polymer materials of the thermoplastic or non-thermoplastic type, mention may for example be made of celluloses, notably rayon, polyvinyl alcohols (abbreviated to “PVAs”), polyketones, aramids (aromatic polyamides), aromatic polyesters, polybenzazoles (abbreviated to “PBOs”), polyimides, polyesters, notably those selected from among PET (polyethylene terephthalate), PEN (polyethylene naphthalate), PBT (polybutylene terephthalate), PBN (polybutylene naphthalate), PPT (polypropylene terephthalate), PPN (polypropylene naphthalate).

For preference, the tyre comprises a tread positioned radially on the outside of the crown reinforcement and intended to be in contact with the ground when the tyre is being driven on.

In certain embodiments, the carcass ply is obtained from the composite by shaping a green tyre. In these embodiments, use is made of a building drum the overall shape of which is that of a toroid about an axis of the drum, the drum having a laying surface in contact with which the composite according to the invention is wound, this composite then forming a cylindrical winding that is axially and circumferentially continuous. The composite may be laid directly in contact with the laying surface or alternatively on a radially inner ply, for example an airtight inner-liner ply, itself wound in contact with the laying surface. In most embodiments, the composite is laid in just one turn of cylindrical winding. Optionally, other plies are laid on the composite.

The laying surface is then distanced radially from the axis of the drum, for example by pressurizing, using an inflation gas, an annular space inside the laying surface, for example using air. This step is referred to as shaping because the green tyre is deformed in such a way as to obtain a shape suited to the subsequent laying of the crown reinforcement and of the tread. This shaping causes the density of reinforcing elements in the carcass ply obtained from the composite according to the invention to vary according to whether it is in the bead or whether it is radially below the crown reinforcement. This then yields a shaped green form of the tyre.

Next, the crown reinforcement and the tread are added to the shaped green form of the tyre.

Finally, the laying surface is brought radially closer to the axis of the drum, for example by depressurizing the annular space.

The tyre in the raw state is thus obtained. Finally, the tyre is crosslinked, for example by vulcanization, in order to obtain the tyre in the cured state.

In certain embodiments, the tyre has an aspect ratio ranging from 30 to 55, and preferably from 30 to 50. The aspect ratio or nominal aspect ratio is the ratio, expressed as a percentage, of the section height of the tyre to the nominal width of the cross section of the tyre as defined in the ETRTO (European Tyre and Rim Technical Organization) document “Engineering Design Information”, 2010, at paragraph D, on page GI.5. All other things being equal, the lower the aspect ratio, the more sensitive the tyre is to road hazards, notably those involving the carcass ply becoming pinched (more properly referred to as “pinch shock”). Thus, the tyres that have an aspect ratio lower than or equal to 55 are particularly sensitive to pinch shock. Surprisingly, tyres with an aspect ratio lower than or equal to 55 but comprising carcass ply reinforcing elements according to the invention are no more sensitive than analogous tyres having higher aspect ratios, for example higher than 55, unlike in tyres of the prior art, for example comprising carcass ply reinforcing elements made of polyester, which are extremely sensitive to pinch shock at aspect ratios lower than or equal to 55, whereas this sensitivity is moderate for analogous tyres having higher aspect ratios, for example higher than 55.

In other embodiments, the tyre has an aspect ratio greater than or equal to 55, preferably ranging from 55 to 75, and more preferably from 60 to 70. A tyre having such an aspect ratio is generally used on vehicles of the 4×4 or SUV type and is intended to encounter particular uses, notably off-road and/or heavily-laden uses. The tyres of the prior art that have such an aspect ratio comprise a carcass reinforcement comprising two carcass plies in order to cope with these particular uses. Thanks to the composite described hereinabove, such tyres are able to comprise just one single carcass ply and cope with the particular uses they are intended to encounter.

In one embodiment, the tyre comprises two sidewalls, each sidewall has a mean thickness, measured in a median tangential plane of the tyre, of less than 10 mm. Such a tyre is not designed to run flat. This sidewall thickness is the distance measured between the external surface of the tyre and the internal surface of the tyre in the median tangential plane. The median tangential plane of the tyre is the plane perpendicular to the median circumferential plane and radially equidistant from a first tangential plane passing through the external surface of the tread and from a second tangential plane passing through the radially internal end of the tyre.

In another embodiment, the tyre is designed to be a run-flat tyre. In general, the ability of the tyre to be designed to run flat is indicated on the sidewall of the tyre, notably by a logo or distinctive marking, for example “SSR” (for Self Supporting Runflat), “SST” (for Self Supporting Tyre), “RFT”, “ROF” (for Run On Flat), “RME” (for Extended Mobility Technology), “Run-On-Flat” or alternatively “ZP” (for Zero Pressure) or more simply “Run Flat”.

For preference, in the embodiment in which the tyre is designed to run flat, the tyre comprises a sidewall insert positioned axially on the inside of the carcass reinforcement.

For preference, in the embodiment in which the tyre is designed to run flat, the tyre comprises two sidewalls, each sidewall has a mean thickness, measured in a median tangential plane of the tyre, greater than or equal to 10 mm. The thickness of each sidewall and the median tangential plane are as defined hereinabove.

Specifically, for several years, tyre manufacturers have sought to eliminate the need for the presence of a spare wheel on board the vehicle while at the same time guaranteeing that the vehicle will be able to continue its journey despite a significant or complete loss of pressure from one or more of the tyres. That for example allows a service centre to be reached without the need to stop, under circumstances that are often hazardous, in order to fit the spare wheel.

One envisaged solution is the use of tyres designed to run flat and provided with self-supporting sidewalls.

When the inflation pressure is close to the service pressure (this is then referred to as “normal running” mode), it is desirable for the tyre to exhibit performance, referred to as “IM” (inflated mode) running performance, that is as good as possible. This IM running performance includes, amongst other things, the mass, the rolling resistance or even the comfort.

When the inflation pressure is significantly reduced in comparison with the service pressure, or is even zero (this is then referred to as “run-flat” mode), the tyre must make it possible to cover a given distance at a given speed. This performance, referred to as “EM” (extended mobility) running performance, is required by legislation or by motor vehicle manufacturers in order to allow the producer to advertise the tyre as being a run-flat tyre. This performance is largely dependent on the durability of the reinforcing elements of the carcass reinforcement, which durability is sufficient using the reinforcing elements according to the invention.

Specifically, the reinforcing element has a relatively low modulus at low deformations (in normal running mode), in this instance that of the polyester strand, which proves to be compatible with IM running performance. The reinforcing element has a relatively high modulus at high deformations (in run-flat mode), in this instance that of the aromatic polyamide or aromatic copolyamide strand, which proves to be sufficient to, on its own, provide EM running performance.

The invention will be better understood in the light of the following description, which is given solely by way of non-limiting example and with reference to the drawings in which:

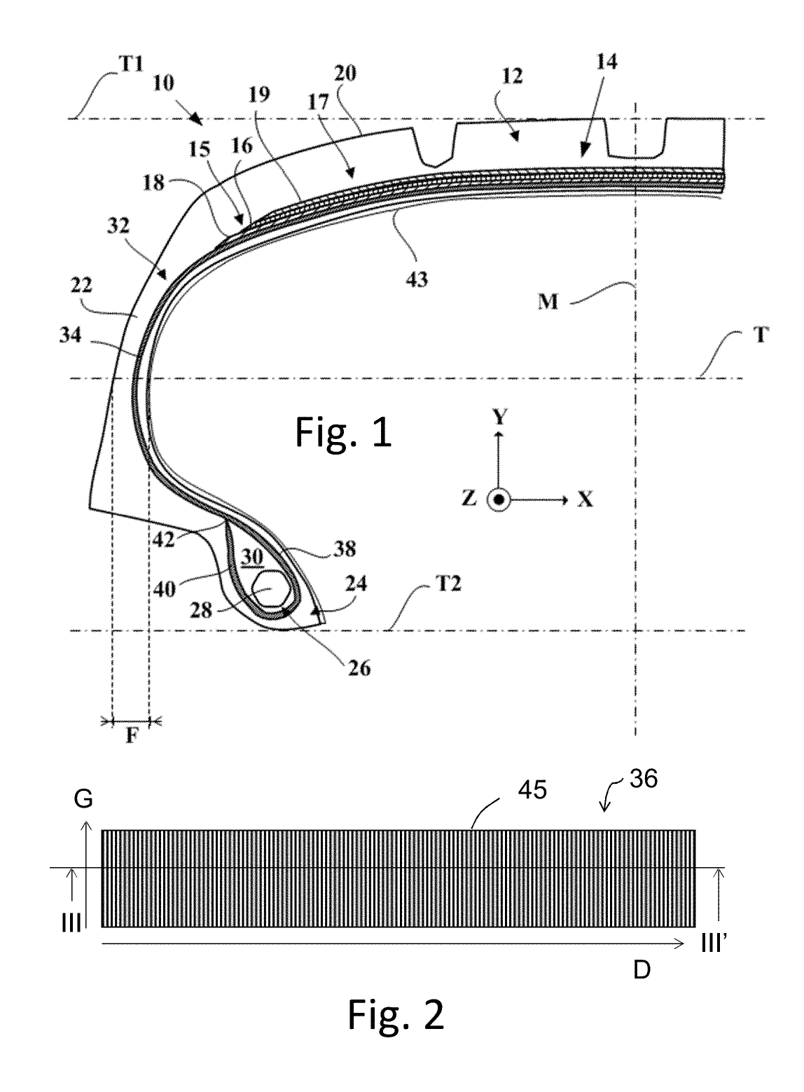

FIG. 1 is a view in radial section of a tyre according to a first embodiment of the invention;

FIG. 2 illustrates a composite that can be used to obtain a carcass ply of the tyre of FIG. 1;

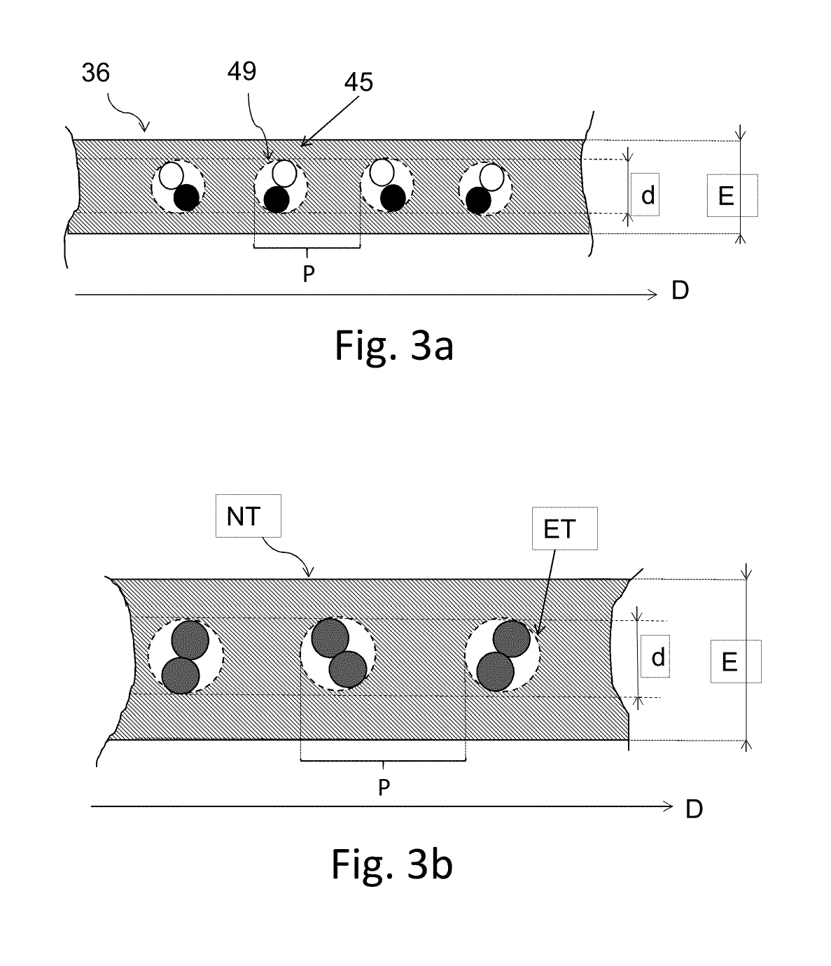

FIG. 3a illustrates a view, in cross section on III-III′, of the composite of FIG. 2;

FIG. 3b is a view, similar to that of FIG. 3a, of a composite of the prior art;

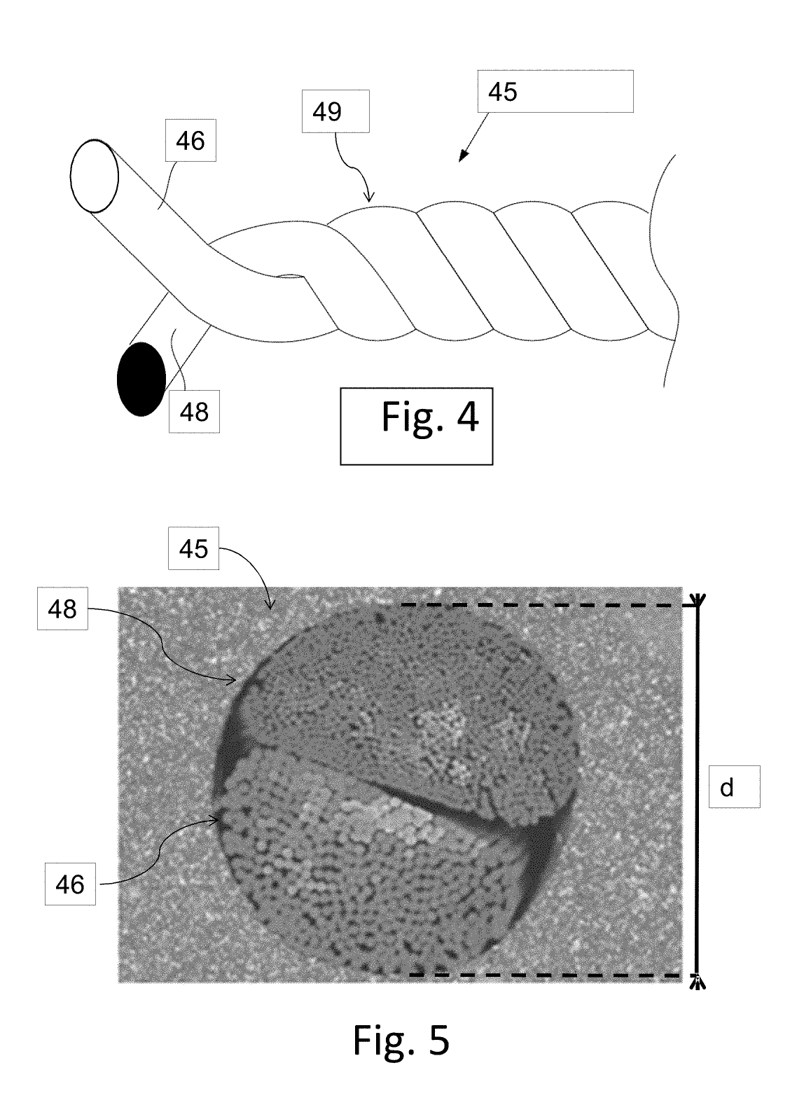

FIG. 4 illustrates a detail view of a reinforcing element of the tyre of FIG. 1, and of the composite of FIG. 2;

FIG. 5 is an enlargement of a view in cross section of a reinforcing element according to the invention; and

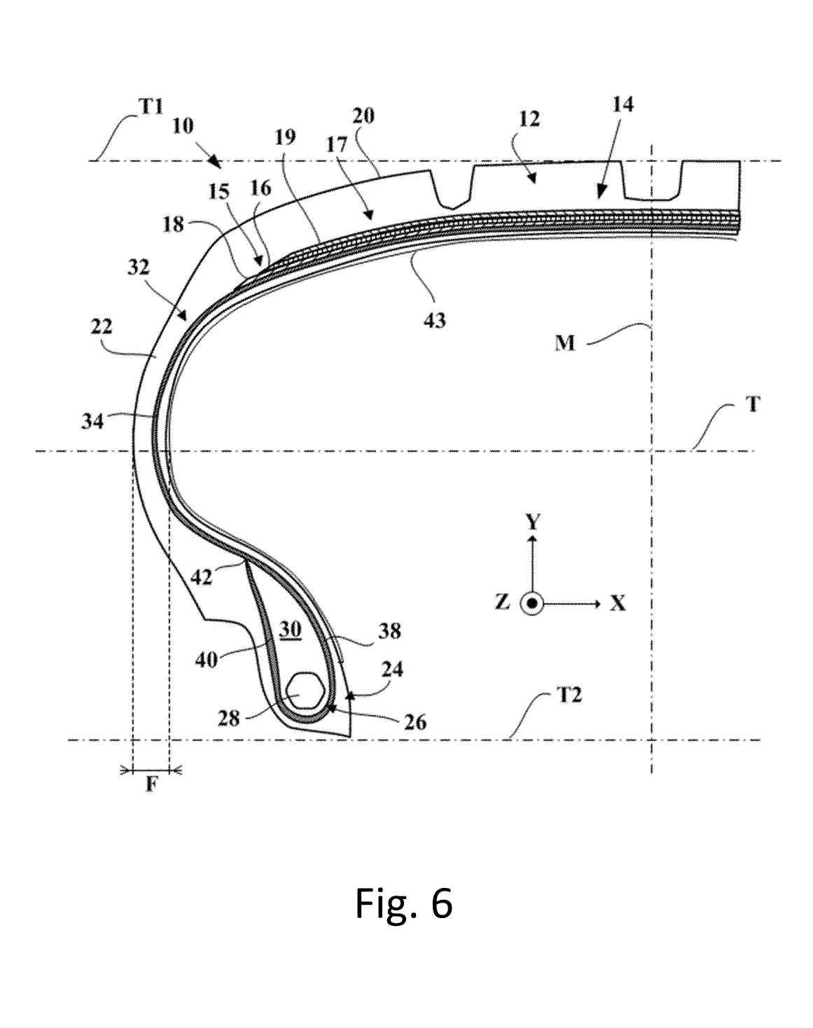

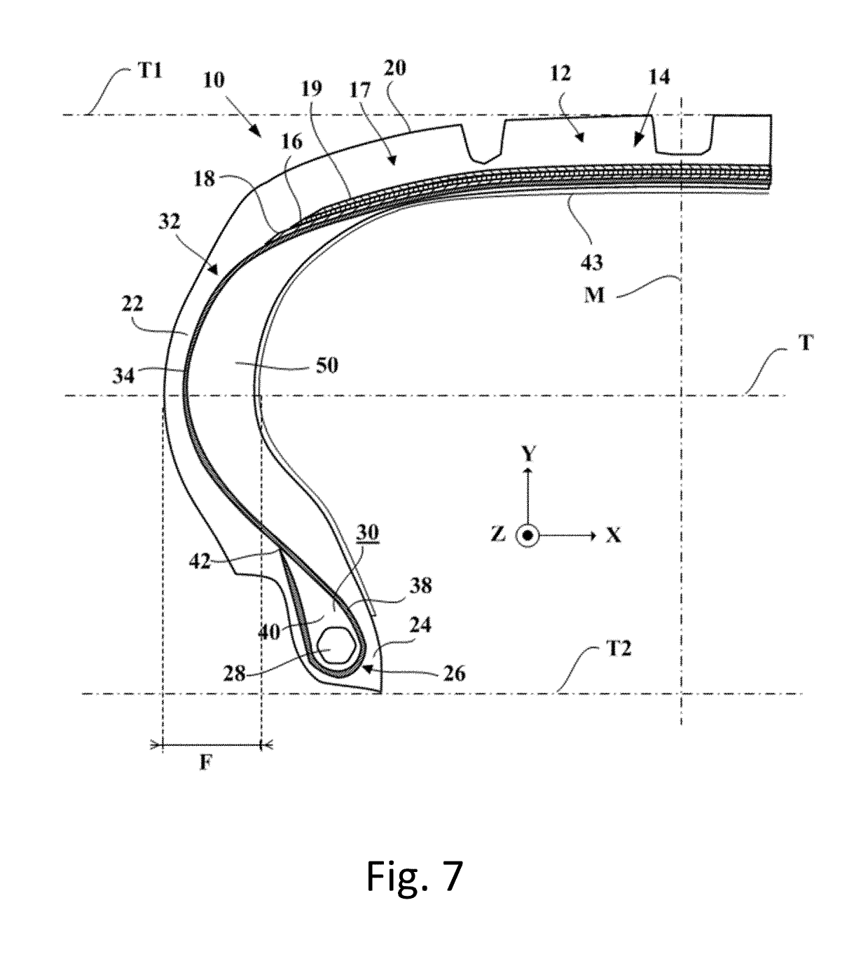

FIGS. 6 and 7 are views similar to that of FIG. 1 of tyres respectively according to second and third embodiments of the invention.

When using the term “radial”, a distinction should be made between several different uses of the word by the person skilled in the art. Firstly, the expression refers to a radius of the tyre. It is in that sense that a point A is said to be “radially inside” a point B (or “radially on the inside of” the point B) if it is closer to the axis of rotation of the tyre than is the point B. Conversely, a point C is said to be “radially outside” a point D (or “radially on the outside of” the point D) if it is further from the axis of rotation of the tyre than is the point D. Progress “radially inwards (or outwards)” will mean progress towards smaller (or larger) radii. It is this sense of the word that applies also when radial distances are being discussed.

A “radial cross section” or “radial section” here means a cross section or a section in a plane which contains the axis of rotation of the tyre.

The “median circumferential plane” M of the tyre is the plane which is normal to the axis of rotation of the tyre and which is situated equidistantly from the annular reinforcing structures of each bead.

As already described hereinabove, the “median tangential plane” T of the tyre is the plane perpendicular to the “median circumferential plane” M and radially equidistant from a first tangential plane T1 passing through the external surface of the tread and from a second tangential plane T2 passing through the radially internal end of the tyre.

An “axial” direction is a direction parallel to the axis of rotation of the tyre.

A “circumferential” direction is a direction which is perpendicular both to a radius of the tyre and to the axial direction.

As already described hereinabove, F is the mean thickness of the sidewall of the tyre measured in the median tangential plane, namely the distance measured between the external wall and the internal wall of the tyre in the median tangential plane. This thickness is a mean thickness because it is calculated over 5 values measured on 5 sections uniformly circumferentially distributed over the tyre.

In the present application, unless specified otherwise, any range of values denoted by the expression “from a to b” means the range of values ranging from the end point “a” to the end point “b”, i.e. including the strict end points “a” and “b”.

Tyre According to a First Embodiment of the Invention

A frame of reference X, Y, Z corresponding to the usual respectively axial (X), radial (Y) and circumferential (Z) directions of a tyre has been depicted in the figures.

FIG. 1 schematically depicts a view in radial section of a tyre according to a first embodiment of the invention and denoted by the general reference 10. The tyre 10 substantially exhibits revolution about an axis substantially parallel to the axial direction X. The tyre 10 here is intended for a passenger vehicle. The tyre 10 has an aspect ratio ranging from 30 to 55, and preferably from 30 to 50. In this particular instance, the tyre is of the size 245/40 R18 and therefore has an aspect ratio equal to 40. The tyre 10 according to the first embodiment is not designed to run flat.

The tyre 10 comprises a crown 12 comprising a crown reinforcement 14 comprising a working reinforcement 15 comprising two working plies 16, 18 of working reinforcing elements and a hoop reinforcement 17 comprising a hooping ply 19 of hoop reinforcing elements. The crown reinforcement 14 is surmounted by a tread 20 arranged radially on the outside of the crown reinforcement 14. In this case, the hoop reinforcement 17, in this case the hooping ply 19, is radially interposed between the working reinforcement 15 and the tread 20.

The tyre also comprises two sidewalls 22 extending the crown 12 radially inwards. The tyre 10 further comprises two beads 24 radially on the inside of the sidewalls 22 and each comprising an annular reinforcing structure 26, in this instance a bead wire 28, surmounted by a mass of bead apex filling rubber 30, and also a radial carcass reinforcement 32.

The carcass reinforcement 32 comprises at least one carcass ply comprising several reinforcing elements, the ply being anchored to each of the beads 24 by a turn-up around the bead wire 28, so as to form, within each bead 24, a main strand 38 extending from the beads through the sidewalls towards the crown 12, and a turn-up strand 40, the radially outer end 42 of the turn-up strand 40 being radially on the outside of the annular reinforcing structure 26. The carcass reinforcement 32 thus extends from the beads 24 through the sidewalls 22 as far as into the crown 12. The carcass reinforcement 32 is arranged radially on the inside of the crown reinforcement 14 and of the hoop reinforcement 17. The carcass reinforcement 32 comprises a single carcass ply 34.

The tyre 10 also comprises an airtight inner liner 43, preferably made of butyl, located axially on the inside of the sidewalls 22 and radially on the inside of the crown reinforcement 14 and extending between the two beads 24.

The mean thickness F of each sidewall 22 of the tyre 10, measured in the median tangential plane T, is less than 10 mm. In this particular instance, the mean thickness F is equal here to 5 mm.

Each working ply 16, 18, hooping ply 19 and carcass ply 34 comprises a polymer composition in which reinforcing elements of the corresponding ply are embedded. Each polymer composition, here an elastomer composition, of the working plies 16, 18, hooping ply 19 and carcass ply 34 is made from a conventional composition for the skimming of reinforcing elements conventionally comprising a diene elastomer, for example natural rubber, a reinforcing filler, for example carbon black and/or silica, a crosslinking system, for example a vulcanization system, preferably comprising sulfur, stearic acid and zinc oxide, and possibly a vulcanization accelerator and/or retarder and/or various additives.

Composite According to the Invention

A composite from which the carcass ply 34 is obtained will now be described with reference to FIGS. 2, 3a and 4.

The composite comprises several reinforcing elements. The reinforcing elements are arranged side-by-side and parallel to one another in a main direction D substantially perpendicular to the overall direction G in which the reinforcing elements of the carcass ply extend, the overall direction G making an angle ranging from 80° to 90° with the circumferential direction Z of the tyre 10 once the composite that forms the carcass ply 34 is in the tyre 10. In this particular instance, the overall direction G makes an angle substantially equal to 90° with the circumferential direction Z of the tyre 10 once the composite that forms the carcass ply 34 is in the tyre 10.

A reinforcing element 45 and the corresponding assembly 49 will be described hereinbelow. A composite 36 corresponding to the reinforcing element 45 will also be described.

Nature of the Strands of the Reinforcing Element

As depicted schematically in FIG. 4, the reinforcing element 45 comprises an assembly 49 made up of a multifilament strand made of aromatic polyamide or of aromatic copolyamide 46 and a multifilament strand made of polyester 48, the two strands 46, 48 being wound in a helix one around the other. The reinforcing element 45 is twist-balanced. For the sake of the accuracy of the description, FIG. 5 is a view in cross section of the reinforcing element 45 according to the invention, in which the monofilaments of each of the strands can be discerned.

The aromatic polyamide selected is, in this instance, preferably a para-aramid known by the Teijin company trade name of Twaron 1000. The polyester is polyethylene terephthalate (PET) known by the Hyosung or Hailide company trade name of PET HMLS (High Module Low Shrinkage).

In certain embodiments which have not been depicted, the reinforcing element 45 comprises, in addition to the assembly 49, a layer of an adhesive composition coating the assembly 49.

Count of the Reinforcing Element

The count of the multifilament strand 46 made of aromatic polyamide or aromatic copolyamide ranges from 140 to 210 tex, preferably from 150 to 190 tex, and more preferably from 160 to 180 tex.

In the reinforcing element 45, the count of the strand 46 is equal to 167 tex.

The count of the multifilament strand 48 made of polyester ranges from 100 to 210 tex, preferably from 120 to 190 tex, more preferably from 130 to 180 tex, more preferably still from 160 to 180 tex.

In the reinforcing element 45, the count of the strand 48 is equal to 167 tex.

Twist of the Reinforcing Element

In the reinforcing element 45, the twist of the reinforcing element ranges from 275 to 365 twists per metre, preferably from 275 to 350 twists per metre, and more preferably from 300 to 330 twists per metre. In this particular instance, the twist of the reinforcing element 45 is equal to 315 twists per metre.

Initial and Final Modulus of the Reinforcing Element

The initial tensile modulus of each reinforcing element 45 ranges from 5.0 to 10.5 cN/tex.

In the reinforcing element 45, the initial tensile modulus of the reinforcing element advantageously ranges from 5.7 to 8.5 cN/tex, preferably from 6.2 to 7.8 cN/tex, and more preferably from 6.8 to 7.5 cN/tex. In this particular instance, the initial modulus of the reinforcing element 45 is equal to 7.2 cN/tex.

The final tensile modulus of the reinforcing element 45 ranges from 14.0 to 21.5 cN/tex.

In the reinforcing element 45, the final tensile modulus of the reinforcing element advantageously ranges from 15.0 to 19.0 cN/tex, preferably from 15.8 to 18.5 cN/tex, and more preferably from 16.6 to 17.9 cN/tex. In this particular instance, the final modulus of the reinforcing element 45 is equal to 16.9 cN/tex.

The ratio of the final modulus to the initial modulus ranges from 2.10 to 2.75.

In the reinforcing element 45, the ratio of the final modulus to the initial modulus advantageously ranges from 2.15 to 2.45, preferably from 2.20 to 2.40 and more preferably from 2.25 to 2.40. In this particular instance, the ratio of the final modulus to the initial modulus of the reinforcing element 45 is equal to 2.34.

Twist Factor of the Reinforcing Element

The twist factor K of the reinforcing element 45 ranges from 5.5 to 6.5.

Preferably, in the reinforcing element 45, the twist factor K belongs to the interval ]5.5; 6.5] (which means to say excluding the value 5.5), preferably from 5.6 to 6.1, and more preferably still from 5.9 to 6.1. In this particular instance, the twist factor K of the reinforcing element 45 is equal to 6.0.

Geometric Characteristics of the Composite

Returning to FIG. 3a, the composite 36 has a thickness E and the reinforcing element 45 has a diameter d. The diameter d corresponds to the diameter of the theoretical circle inside which the reinforcing element can be inscribed. In this FIG. 3a, each strand has deliberately been depicted schematically for the sake of simplifying the description. FIG. 5 illustrates the reinforcing element 45 as it actually would appear.

The diameter of the reinforcing element 45 is less than or equal to 0.95 mm, preferably less than or equal to 0.80 mm, more preferably less than or equal to 0.70 mm. The reinforcing element 45 has a diameter d=0.67 mm.

The thickness E of the composite 36 is less than or equal to 1.45 mm, preferably less than or equal to 1.30 mm, more preferably less than or equal to 1.20 mm. The reinforcing element 45 has a thickness E=1.10 mm.

Thus, the ratio d/E is strictly less than 0.65, preferably less than or equal to 0.62. The reinforcing element 45 has a ratio d/E=0.61.

The density of the reinforcing element 45 in the composite 36 ranges from 90 to 130 reinforcing elements per decimetre of each composite 36, preferably from 100 to 125 reinforcing elements per decimetre of the composite 36, and more preferably from 105 to 120 reinforcing elements per decimetre of the composite 36. For the composite 36, the density of reinforcing elements 45 is equal to 110 reinforcing elements per decimetre of composite 36.

FIG. 3a depicts the pitch P which is the distance separating two analogous points of two adjacent reinforcing elements 45. The pitch P is generally referred to as the laying pitch at which the reinforcing elements are laid in the composite. The pitch P and the density of reinforcing elements per decimetre of composite are such that the density of reinforcing elements per decimetre of composite is equal to 100/P.

The density of reinforcing elements and the thickness which are described hereinabove are, as explained previously, the density of reinforcing elements 45 and the thickness E of the composite 36. In the tyre 10, as the carcass ply 34 is obtained from the composite 36 by shaping a green tyre, the density of reinforcing elements and the thickness of the carcass ply 34 differ from those of the composite and vary according to their distance away from the axis of revolution of the tyre. These variations are notably dependent on the shape factor of the green form of the tyre and also on the geometry thereof. A person skilled in the art will be able, notably on the basis of the shape factor of the green form of the tyre and of the geometry thereof, to determine the characteristics of the corresponding composite.

Method for Manufacturing the Reinforcing Element

As described hereinabove, the reinforcing element 45 is twist-balanced, which means to say that the two multifilament strands are wound with substantially the same twist and that the twist of the monofilaments in each multifilament strand is substantially zero. In a first step, each spun yarn of monofilaments (more properly referred to as a “yarn”) is first of all twisted individually on itself with an initial twist equal to 315 twists per metre in a given direction, in this instance the Z direction, to form a strand or overtwist (more properly referred to as a “strand”). Then, during a second step, the two strands are then twisted together with a final twist equal to 315 twists per metre in the S direction to obtain the assembly of the reinforcing element (more properly referred to as a “cord”).

In later steps, each assembly is coated with an adhesive composition, for example an adhesive composition of the RFL (Resorcinol-Formaldehyde-Latex) type, and undergoes heat treatment steps in order to at least partially crosslink the adhesive composition.

Method for Manufacturing the Composite According to the Invention

The composite 36 is manufactured by embedding several reinforcing elements 45 in the elastomer composition, for example by skimming. During such a skimming step, which is well known to those skilled in the art, reinforcing elements are moved along, and two strips made of an elastomer composition, and referred to as skims, are brought in, one on each side of the reinforcing elements, so that the reinforcing elements are sandwiched between the two skims. The reinforcing elements are thus embedded in the elastomer composition.

Method for Manufacturing the Tyre According to the Invention

The method for manufacturing the tyre is the one conventionally used by those skilled in the art. During the course of this method and as already described hereinabove, various plies and composite, including the composites according to the invention which is intended to form the carcass ply 34 of the tyre 10, are successively laid, during a first series of tyre building steps. The green form thus obtained is then shaped. Next, other plies and composites intended to form the crown 12 of the tyre 10 are laid. Finally, the green form thus obtained is vulcanized in order to obtain the tyre 10.

Tyre According to a Second Embodiment of the Invention

FIG. 6 depicts a tyre according to a second embodiment of the invention. Elements similar to those of the first embodiment are denoted by identical references.

Unlike the tyre 10 according to the first embodiment, the tyre 10 according to the second embodiment has an aspect ratio higher than or equal to 55, preferably ranging from 55 to 75. In this particular instance, the tyre is of the size 205/55 R16 and therefore has an aspect ratio equal to 55.

Tyre According to a Third Embodiment of the Invention

FIG. 7 depicts a tyre according to a third embodiment of the invention. Elements similar to those of the first embodiment are denoted by identical references.

Unlike the tyre 10 according to the first embodiment, the tyre 10 according to the third embodiment is a tyre designed to run flat. Thus, the tyre is configured in such a way as to withstand a load corresponding to a portion of the weight of the vehicle during a run-flat situation, namely with a pressure substantially equal to atmospheric pressure.

The tyre 10 according to the third embodiment comprises two self-supporting sidewalls 22 extending the crown 12 radially inwards. For this purpose, the tyre 10 comprises two sidewall inserts 50, axially on the inside of the carcass reinforcement 32 and axially on the outside of the airtight inner liner 43. Thus, the sidewall inserts 50 are positioned axially between the carcass reinforcement 32 and the airtight inner liner 43.

These inserts 50 with their characteristic crescent-shaped radial cross section are intended to reinforce the sidewalls 22. Each insert 50 is made from a specific elastomer composition. Document WO 02/096677 gives several examples of specific elastomer compositions that can be used to form such an insert. Each sidewall insert 50 is capable of contributing towards withstanding a load corresponding to a portion of the weight of the vehicle during a run-flat situation.

Unlike in the first embodiment of the tyre, each sidewall 22 has a mean thickness F, measured in the median tangential plane T, that is greater than or equal to 10 mm. In this particular instance, the mean thickness F is equal here to 17 mm.

Comparative Tests and Measurements

By way of a comparative example, FIG. 3b depicts a composite of the prior art denoted by the general reference NT of a tyre of the prior art. The composite NT comprises reinforcing elements ET each comprising an assembly made up of two multifilament strands made of polyester which are assembled with one another and wound in a helix around one another at a twist of 270 twists per metre. Each reinforcing element ET is twist-balanced. Each multifilament strand of the reinforcing element ET has a count equal to 334 tex.

Use was also made of a control composite NT′ comprising control reinforcing elements ET′ each comprising an assembly made up of a multifilament strand made of aromatic polyamide or aromatic copolyamide, and a multifilament strand made of polyester which are assembled with one another and wound in a helix around one another at a twist of 290 twists per metre. Each reinforcing element ET′ is twist-balanced. The multifilament strand of aromatic polyamide or aromatic copolyamide, in this case para-amide identical to that of the reinforcing element 45, has a count equal to 167 tex. The multifilament strand of polyester, in this case of PET identical to that of the reinforcing element 45, has a count equal to 144 tex.

Comparison Between Reinforcing Elements

Table 1 summarizes the characteristics of the reinforcing element 45 of the tyre 10 according to the invention, of the control reinforcing element ET′ and of the reinforcing element ET of the prior art. The force at break measurements are taken under tensile testing according to standard ISO 6892, 1984.

TABLE 1

| | ET | ET′ | 45 |
|---|---|---|---|
| Nature of the strands | PET/PET | p-Aramid/ | p-Aramid/ |
| | | PET | PET |
| Initial modulus at 20° C. (cN/tex) | 5.0 | 8.2 | 7.2 |
| Final modulus at 20° C. (cN/tex) | 3.6 | 18.9 | 16.9 |
| Ratio of final modulus to initial | 0.72 | 2.29 | 2.34 |
| modulus at 20° C. | | | |
| Twist (t/m) | 270 | 290 | 315 |
| Count of the strands (tex) | 334/334 | 167/144 | 167/167 |
| Twist factor K | 7.3 | 5.3 | 6.0 |
| Force at break (daN) | 40 | 36.8 | 39.6 |

Note that the reinforcing element 45 has initial and final modulus values that are significantly higher than those of the reinforcing element of the prior art ET.

The force at break value of the reinforcing element 45 is high enough to effectively combat road hazards. It will be noted that the force at break of the reinforcing element 45 is greater than that of the control reinforcing element ET′ and is almost dentical to that of the reinforcing element ET.

Comparison of the Composites

The composite 36 according to the invention comprising reinforcing elements 45 was compared with the control composite NT′ comprising the control reinforcing elements ET′ and a composite NT of the prior art comprising reinforcing elements ET. The geometric characteristics of these composites are collated in Table 2 below.

TABLE 2

| | Composite | | |
|---|---|---|---|
| | NT | NT′ | 36 |
| | Reinforcing element | | |
| | ET | 44 | 45 |
| Density (reinforcing | 80 | 116 | 110 |
| elements/dm) | | | |
| Diameter d of the | 0.96 | 0.65 | 0.67 |
| reinforcing element | | | |
| (mm) | | | |
| Thickness E of the | 1.47 | 1.16 | 1.10 |
| composite (mm) | | | |
| Ratio d/E | 0.65 | 0.56 | 0.61 |
| Force at break of the | 320 | 427 | 436 |
| composite (daN/cm) | | | |

Note that the reinforcing element ET of the prior art has a diameter d very much greater than that of the reinforcing elements 45 of the composite according to the invention. The composite 36 according to the invention is far thinner than the composite NT and than the composite NT′. The ratio d/E of the composite 36 is smaller than the ratio d/E of the composite of the prior art which means that the composite 36 is lighter in weight.

It will be noted that, in addition to being more lightweight, the composite 36 has a significantly higher force at break than the composite NT and than the composite NT′.

Force at Break of the Reinforcing Elements

Table 3 gives the force at break of reinforcing elements comprising a multifilament strand made of aramid (Twaron 1000 by the company Teijin) having a count equal to 167 tex and a multifilament strand made of PET (PET HMLS by the company Hyosung) having a count equal to 144 tex, the two strands being wound in a helix one around the other and each reinforcing element being twist-balanced. The twist was varied in such a way as to vary the twist factor K from 3.7 to 7.0. The force at break measurements are taken under tensile testing according to standard ISO 6892, 1984.

TABLE 3

| | Twist factor K | | | | | | | | | | | |
|---|---|---|---|---|---|---|---|---|---|---|---|---|
| | 3.7 | 4.0 | 4.2 | 4.6 | 5.0 | 5.3 | 5.5 | 5.6 | 5.9 | 6.3 | 6.6 | 7.0 |
| Force at | 38.1 | 39.3 | 38.5 | 38.2 | 37.0 | 36.8 | 37.0 | 36.6 | 37.0 | 36.8 | 34.2 | 34.9 |
| break (daN) | | | | | | | | | | | | |

Table 4 then gives the force at break of reinforcing elements comprising a multifilament strand made of aramid (Twaron 1000 by the company Teijin) having a count equal to 167 tex and a multifilament strand made of PET (PET HMLS by the company Hailide) having a count equal to 167 tex, the two strands being wound in a helix one around the other and each reinforcing element being twist-balanced. The twist was varied in such a way as to vary the twist factor K from 4.6 to 7.0. The force at break measurements are taken under tensile testing according to standard ISO 6892, 1984.

TABLE 4

| | Twist factor K | | | | | | | | |
|---|---|---|---|---|---|---|---|---|---|
| | 4.6 | 4.8 | 5.2 | 5.3 | 5.5 | 5.7 | 6.0 | 6.5 | 7.0 |
| Force at | 42.0 | 41.1 | 40.1 | 40.7 | 40.0 | 39.8 | 39.6 | 39.7 | 37.1 |
| break (daN) | | | | | | | | | |

Tables 3 and 4 show that, for a given count, in the interval of twist factors K ranging from 5.5 to 6.5, the force at break of each reinforcing element is substantially constant. Thus, as described hereinabove, in the selected twist-factor interval, the tyre designer can adapt other characteristics of the reinforcing element, notably the twist, to suit the use or uses for which the tyre is intended, notably in order to vary the durability as explained hereinbelow.

Durability of the Reinforcing Elements

The durability of the reinforcing element 45 was compared against that of other aramid/PET reinforcing elements I, II, III and ET′. The reinforcing elements II and 45 are in accordance with the invention. The reinforcing elements I, III and ET′ are not in accordance with the invention. In order to evaluate durability, reinforcing elements were embedded in an elastomer composition in order to form a test specimen in the form of a strip with a thickness equal to 30 mm which was cycled around a cylindrical bar. After 190,000 cycles, the final force at break of each reinforcing element was measured. The drop-off, corresponding to the loss, as a %, in the force at break after the 190,000 cycles, was then calculated. The higher the drop-off, the lower the durability. The results of the tests and the characteristics of the reinforcing elements tested are collated in Table 5 below.

TABLE 5

| | Reinforcing element | | | | |
|---|---|---|---|---|---|
| | I | II | III | ET′ | 45 |
| Count of aramid/ | 167/167 | 167/167 | 167/144 | 167/144 | 167/167 |
| PET strands (tex) | | | | | |
| Twist factor K | 5.3 | 5.7 | 7.0 | 5.3 | 6.0 |
| Initial force at break | 40.7 | 39.8 | 34.9 | 36.8 | 39.6 |
| (daN) | | | | | |
| Final force at break | 18.2 | 23.2 | 27.5 | 18.7 | 28.0 |
| (daN) | | | | | |
| Drop-off (%) | 55.3 | 41.7 | 21.2 | 49.2 | 29.3 |

The results for the reinforcing elements II and 45 show that, for given strand counts, within the twist-factor K interval ranging from 5.5 to 6.5, the durability can be varied according to the desired use of the tyre, for example by varying the twist. Thus, the tyre designer can vary the durability according to the specific use for which the tyre is intended, for example a sporting use by increasing the twist, or alternatively may select a durability compatible with most present-day tyre uses, by selecting a lower twist.

These results show that the reinforcing element 45 has both a relatively high initial force at break and a durability close to that of the reinforcing element III having a much higher twist factor. Moreover, in the twist-factor K interval ranging from 5.5 to 6.5, the initial force at break is far higher than that of the reinforcing element III that has a twist factor above the interval.

Comparison of the Tyres

The tyre 10 according to the invention was compared against a tyre PT of the prior art comprising a carcass ply obtained from the composite NT.

The masses of the tyres 10 and PT were compared by weighing the tyres tested. The results of this test are collated in Table 6 below.

TABLE 6

| Tyre | PT | 10 |
|---|---|---|
| Mass | 10.27 kg | 10.06 kg |

Thus it is noted that the tyre 10 exhibits a lower mass in comparison with the tyre of the prior art PT.

The invention is not limited to the embodiments described above.

In embodiments not described hereinabove, the tyre may have an aspect ratio ranging from 60 to 70.

It will also be possible to combine the characteristics of the various embodiments and alternative forms described or envisaged hereinabove, provided that these characteristics are compatible with one another.

1.-22. (canceled)

23. A reinforcing element comprising an assembly made up of:
a multifilament strand made of aromatic polyamide or aromatic copolyamide; and
a multifilament strand made of polyester,
wherein the two multifilament strands are wound in a helix around one another and the reinforcing element is twist-balanced, the twist factor K of the reinforcing element ranging from 5.5 to 6.5 with K being defined by the formula:
K=(R×Ti^{1/2})/957
in which R is the twist of the reinforcing element expressed in twists per meter and Ti is the sum of the counts of the multifilament strands of the reinforcing element in tex.

24. The reinforcing element according to claim 23, wherein the twist factor K of the reinforcing element ranges from 5.5 to 6.5, the value 5.5 being excluded.

25. The reinforcing element according claim 23, wherein the twist of the reinforcing element ranges from 275 to 365 twists per meter.

26. The reinforcing element according to claim 23, wherein a count of the multifilament strand made of aromatic polyamide or aromatic copolyamide ranges from 140 to 210 tex.

27. The reinforcing element according to claim 23, wherein a count of the multifilament strand made of polyester ranges from 100 to 210 tex.

28. The reinforcing element according to claim 23, wherein an initial tensile modulus of the reinforcing element ranges from 5.0 to 10.5 cN/tex.

29. The reinforcing element according to claim 23, wherein a final tensile modulus of the reinforcing element ranges from 14.0 to 21.5 cN/tex.

30. The reinforcing element according to claim 23, wherein a ratio of a final tensile modulus to an initial tensile modulus ranges from 2.10 to 2.75.

31. An elastomer composite comprising at least one reinforcing element according to claim 23 embedded in an elastomer composition.

32. The elastomer composite according to claim 31, wherein a density of reinforcing elements in the composite ranges from 80 to 145 reinforcing elements per decimeter of composite.

33. The elastomer composite according to claim 31, wherein a ratio of the diameter of the reinforcing element to the thickness of the composite is less than 0.65.

34. The elastomer composite according to claim 31, wherein a diameter of the reinforcing element is less than or equal to 0.95 mm.

35. The elastomer composite according to claim 31, wherein the thickness of the composite is less than or equal to 1.45 mm.

36. A tire comprising a carcass reinforcement comprising at least one carcass ply, wherein the at least one carcass ply is obtained from an elastomer composite according to claim 31.

37. The tire according to claim 36, wherein the carcass reinforcement comprises a single carcass ply.

38. The tire according to claim 36, wherein the carcass ply is obtained from the elastomer composite by shaping a green tire.

39. The tire according to claim 36 further comprising two sidewalls, each sidewall having a mean thickness F, measured in a median tangential plane T of the tire of less than 10 mm.

40. The tire according to claim 36, wherein the tire is designed to run flat.

41. The tire according to claim 40 further comprising a sidewall insert positioned axially on the inside of the carcass reinforcement.

42. The tire according to claim 40 further comprising two sidewalls, each sidewall having a mean thickness F, measured in a median tangential plane T of the tire of greater than or equal to 10 mm.
